(19) United States
(12) Patent Application Publication
(10) Pub. No.: US 2004/0060076 A1
(43) Pub. Date: Mar. 25, 2004

(54) Method and apparatus for preventing duplicate recording of a broadcasting program

(75) Inventor: Chun-Hee Song, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/653,929

(22) Filed: Sep. 4, 2003

(30) Foreign Application Priority Data
Sep. 19, 2002 (KR) 2002-57319

(51) Int. Cl. H04N 7/16; G06F 12/00

(52) U.S. Cl. 725/145; 711/154; 711/112

(57) ABSTRACT

A method and apparatus for preventing duplicate recording of a broadcasting program on a recording unit of a TV using additional information included in broadcasting signals. The method includes: reading additional information corresponding to a to-be-recorded broadcasting program before entering a recording mode; searching a recording unit and determining whether the recording unit stores title information corresponding to the to-be-recorded broadcasting program; if the title information corresponding to the to-be-recorded broadcasting program is detected, comparing summary information included in the additional information with that stored in the recording unit in connection with the detected title information and then calculating a correspondence ratio; and comparing the correspondence ratio with a predetermined reference value, and if the correspondence ratio is lower than the predetermined reference value, entering the recording mode to enable recording of the to-be-recorded broadcasting program on the recording unit.

### BACKGROUND OF THE INVENTION

This application claims the priority of Korean Patent Application No. 2002-57319, filed on Sep. 19, 2002, in the Korean Intellectual Property Office, the disclosure of which is incorporated herein in its entirety by reference.

1. Field of the Invention

The present invention relates to a method and apparatus for recording a television (TV) broadcasting program, and more particularly, to a method and apparatus for preventing a duplicate recording of a broadcasting program on a recording unit using additional information included in broadcasting signals.

2. Description of the Related Art

As data processing technologies are developing in the field of television, broadcasting stations can transmit various kinds of additional information, including general information on TV programs, together with video and audio signals, and users can receive through TV receivers and utilize such additional information for many purposes.

In other words, typical analog broadcasting systems have transmitted a very limited amount of additional information. Thus, it has not been possible to provide users with various services because there is a limit to the additional information that can be inserted and transmitted in predetermined intervals of the horizontal synchronization signals. However, recently developed digital broadcasting systems can transmit much additional information for the users' convenience. Such additional information includes not only general information on TV programs but also information regarding education, games, on-line commercial transactions, etc., and the coverage of the additional information is inclined to increase.

In addition, functions of a digital TV receiver are inclined to increase from a basic function of processing the broadcasting signals and outputting them through a display device to a function of recording a broadcasting program on a recording unit, such as a hard disc drive, included in the digital TV receiver in accordance with a user's preferences.

Usually, a broadcasting station produces and broadcasts a limited number of broadcasting programs on a seasonal basis and occasionally rebroadcasts the same programs in regular time periods. In such an environment, if a user has set up the digital TV receiver to implement an automatic recording function for periodically recording certain programs broadcasted in a regular time periods, the rebroadcast programs can be recorded multiple times namely, whenever the broadcasting station rebroadcasts the same programs in the regular time periods. Accordingly, there has been a problem in that the recording unit and/or recording medium included in the digital TV is/are not used effectively and the life thereof is shortened.

### SUMMARY OF THE INVENTION

The present invention provides a method and apparatus for preventing duplicate recording of a broadcasting program on a recording unit of a TV using additional information included in broadcasting signals.

According to an aspect of the present invention, there is provided a method of preventing a duplicate recording of a broadcasting program, which includes the steps of (a) reading additional information corresponding to a to-be-recorded broadcasting program, which includes title information and summary information, from an additional information storing unit before entering a recording mode; (b) searching a recording unit and determining whether the recording unit stores title information corresponding to the to-be-recorded broadcasting program; (c) if the title information corresponding to the to-be-recorded broadcasting program is detected from the recording unit in step (b), comparing summary information included in the additional information read in step (a) with that stored in the recording unit in connection with the detected title information and then calculating a correspondence ratio; and (d) comparing the correspondence ratio calculated in step (c) with a predetermined reference value, and if the correspondence ratio is lower than the predetermined reference value, entering the recording mode to enable recording of the to-be-recorded broadcasting program on the recording unit.

According to another aspect of the present invention, there is provided an apparatus for preventing a duplicate recording of a broadcasting program, which includes a broadcasting signal receiving unit for selecting and demodulating only such broadcasting signals that correspond to a selected channel from received broadcasting signals in accordance with a channel control signal; an additional information storing unit for storing additional information separated from the broadcasting signals received through the broadcasting signal receiving unit; a recording unit for storing a broadcasting program; and a controller for implementing control processes of (a) reading additional information corresponding to a to-be-recorded broadcasting program, which includes title information and summary information, from the additional information storing unit before entering a recording mode, (b) searching the recording unit and determining whether the recording unit stores title information corresponding to the to-be-recorded broadcasting program, (c) if the title information corresponding to the to-be-recorded broadcasting program is detected from the recording unit, comparing summary information included in the additional information read from the additional information storing unit with that stored in the recording unit in connection with the detected title information and then calculating a correspondence ratio, and (d) comparing the calculated correspondence ratio with a predetermined reference value, and if the calculated correspondence ratio is lower than the predetermined reference value, entering the recording mode to enable recording of the to-be-recorded broadcasting program on the recording unit.

### BRIEF DESCRIPTION OF THE DRAWINGS

The foregoing and other aspects and advantages of the present invention will become more apparent by describing in detail preferred embodiments thereof with reference to the attached drawings in which:

FIG. 1 is a block diagram of an apparatus for preventing a duplicate recording of a television broadcasting program according to the present invention; and

FIG. 2 is a flowchart of a method of preventing a duplicate recording of a television broadcasting program according to the present invention.

### DETAILED DESCRIPTION OF THE INVENTION

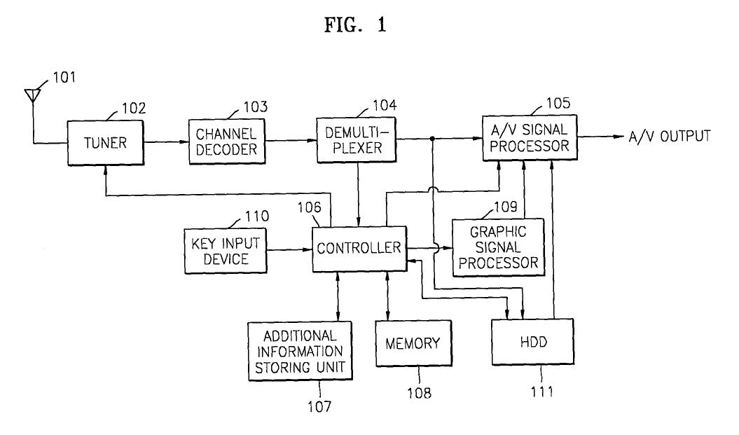

Referring to FIG. 1, an apparatus for preventing a duplicate recording of a TV broadcasting program according to the present invention includes an antenna 101, a tuner 102, a channel decoder 103, a demultiplexer 104, an audio/video (A/V) signal processor 105, a controller 106, an additional information storing unit 107, a memory 108, a graphic signal processor 109, a key input device 110, and a hard disc drive (HDD) 111.

In a digital broadcasting system, audio and video data streams are compressed in a digital information data format, and system and program information are compressed in accordance with a program and system information protocol (PSIP). Information other than audio and video data information, e.g., information regarding a broadcasting program, is decoded and displayed on a screen as electronic program guide (EPG) information using an adequate signal processing procedure via the graphic signal processor 109.

The PSIP is an ATSC standard for digital broadcasting using ground waves or through cables, in which standards for program information and system information are defined. More specifically, the PSIP defines a method of providing various kinds of information on broadcasting programs by parsing broadcasting signals encoded in accordance with an MPEG (Moving Picture Experts Group) standard.

The additional information storing unit 107 stores additional information, including the program information and the system information extracted from the digital broadcasting signals. The additional information stored in the additional information storing unit 107 can be updated when different additional information is received. The additional information includes, e.g., information on a title of program (title information), broadcasting time and date of the program (time information), a size of the program (size information), and a summary of the program (summary information).

The additional information included in the digital broadcasting signal may include program title information, program date information, program time information, program length information, program summary information, and other program identifying information. The program title may also include a program sequence number.

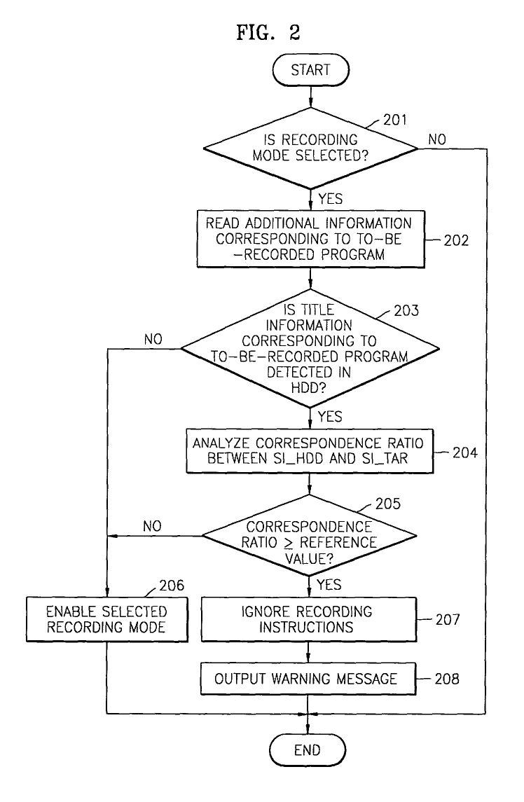

The memory 108 stores control programs and data required for controlling a TV, and particularly a software program for implementing a method of preventing a duplicate recording of a broadcasting program according to the present invention, as shown in a flowchart of FIG. 2.

The HDD 111 is a recording unit on which a broadcasting program is recorded when normal recording, reserved recording, or automatic recording modes are enabled. While the HDD 111 is used as a recording unit in this embodiment, it will be understood that any kind of recording unit other than the HDD 111 can be alternatively used.

The key input device 110 includes a plurality of key buttons to operate the TV. A typical remote controller can be used as the key input device 110.

The apparatus shown in FIG. 1 basically operates as follows. When a TV is powered on and a channel is selected using key buttons of the key input device 110, the tuner 102 receives a channel control signal from the controller 106, and in accordance with the channel control signal, selects such broadcasting signals that correspond to the selected channel from broadcasting signals received through the antenna 101. The selected broadcasting signals are output to the channel decoder 103. Then, the channel decoder 103 recovers digital signals detected from the selected broadcasting signals in the unit of packets and outputs the recovered digital broadcasting signals to the demultiplexer 104. The demultiplexer 104 separates audio data, video data, and additional information data from the recovered digital broadcasting signals and outputs the separated audio, video, and additional information data in different bitstreams.

The audio data and video data are decoded and converted to analog audio and video signals through the A/V signal processor 105, and the converted audio and video signals are output through a speaker (not shown) and a display device (not shown), respectively.

The additional information data, such as EPG information data, is converted to graphic signals through the graphic signal processor 109 and the converted graphic signals are transmitted to the display device through the A/V signal processor 105.

Further, the additional information data separated through the demultiplexer 104 is stored in the additional information storing unit 107. If the additional information data already stored in the additional information storing unit 107 is different from that currently received, the existing additional information data is updated with the currently received data.

The controller 106 implements control processes in correspondence with key values input through the key input device 110. Particularly, in a case where a recording mode is enabled in accordance with an input key value, the controller 106 performs the following control process.

When a user operates the key input device 110 and inputs a certain key value to enable a recording mode, e.g., a normal recording mode, a reserved recording mode, or an automatic recording mode, the controller 106 reads additional information data corresponding to a to-be-recorded broadcasting program from the additional information storing unit 107 before entering the selected recording mode. Then, the title information data corresponding to the to-be-recorded broadcasting program is extracted from the additional information data read from the additional information storing unit 107, and the HDD 111 is searched to detect if the title information data corresponding to the to-be-recorded broadcasting program is stored in the HDD 111. If the additional information data includes sub-title information data, the sub-title information data is also searched for. If the title and/or sub-title information data corresponding to the to-be-recorded broadcasting program is stored in and detected from the HDD 111, summary information data included in the additional information data read from the additional information storing unit 107 is compared with the summary information data stored in the HDD 111 in connection with the detected title and sub-title information data and a correspondence ratio is calculated. When the calculated correspondence ratio is below a predetermined reference value, the selected recording mode is enabled to record the to-be-recorded broadcasting program on the HDD 111. However, if the calculated correspondence ratio is above the predetermined reference value, it is determined that the same broadcasting program with the to-be-recorded broadcasting program exists on the HDD 111. In this event, the recording instruction, i.e., the key value input through the key input device 110 to enable a recording mode, is ignored to prevent duplicate recording of the same broadcasting program.

The automatic recording mode mentioned above is a recording mode for periodically recording programs broadcasted in predetermined time periods, e.g., on a daily or weekly basis, at other regularly occurring periods, or at some other times, such that the targeted recording time is pre-programmed by a user.

The controller 106 can be designed to implement the above described control process only when the automatic recording mode is enabled. However, it is also possible to design the controller 106 to implement the above described control process when another recording mode, e.g., a normal recording mode or a reserved recording mode, is enabled.

Now, a method of preventing a duplicate recording of a television broadcasting program according to the present invention will be described with reference to FIG. 2 together with FIG. 1.

The controller 106 analyzes the key value input through the key input device 110 and determines whether a normal, a reserved, or an automatic recording mode is selected (STEP 201).

If the selected recording mode is the reserved or the automatic recording mode, a specific date and time to record a broadcasting program are set up. As described above, the automatic recording mode is a recording mode for periodically recording programs broadcasted in a predetermined time period, e.g., on a daily or weekly basis, or at other times.

If any recording mode is selected in STEP 201, additional information data corresponding to a to-be-recorded broadcasting program is read from the additional information storing unit 107 (STEP 202). The additional information data read from the additional information storing unit 107 includes title information data, sub-title information data, if any, size information data, time information data, and summary information data.

Thereafter, the HDD 111 is searched to determine whether the HDD 111 stores title information data corresponding to that read from the additional information storing unit 107. If the additional information data includes sub-title information data, comparison of the sub-title information is also carried out (STEP 203).

If the title information data corresponding to that read from the additional information storing unit 107 is not found from the HDD 111, it is determined that the same broadcasting program with the to-be-recorded broadcasting program is not on the HDD 111 and the selected recording mode proceeds normally in accordance with the previously set up conditions (STEP 206).

However, If the title information data and the sub-title information, if any, corresponding to those read from the additional information storing unit 107 are found in the HDD 111, summary information SI_TAR data included in the additional information data read from the additional information storing unit 107 is compared with summary information SI_HDD data stored on the HDD in connection with the title and sub-title information data and a correspondence ratio between the SI_TAR data and the SI_HDD data is calculated (STEP 204). The correspondence ratio can be calculated e.g., by counting the number of the same word data included in each summary information data or by some such other comparison and correspondence scheme suitable to achieve the aims of the present invention.

The correspondence ratio calculated in STEP 204 is compared with a predetermined reference value to determine the correspondence between the broadcasting program already recorded on the HDD 111 and the to-be-recorded program (STEP 205). The predetermined reference value can be a critical value of correspondence ratio, which is determinable through the same software program, and can be experimentally obtained through simulations in accordance with a well-known correspondence ratio analysis technique. Preferably, the reference value is determined to have adequate margins.

If the correspondence ratio is below the predetermined reference value in STEP 205, it is determined that the two compared programs are not the same and a broadcasting program identical to the to-be-recorded program is not recorded on the HDD 111, and the selected recording mode is normally enabled in accordance with the previously set up conditions (STEP 206).

However, if the correspondence ratio is above the predetermined reference value in STEP 205, it is determined that the broadcasting program already recorded on the HDD 111 is the same as the to-be-recorded program, and the recording instructions, i.e., the key value input through the key input device 110 to enable a recording mode is ignored to prevent the duplicate recording of a broadcasting program (STEP 207).

In the event of ignoring the recording instructions, a warning message, e.g., a message informing that the same broadcasting program as the to-be-recorded program has been detected from the HDD 111 is produced and displayed on the screen using an on-screen display (OSD) function through a graphic signal processor 109 (STEP 208).

As described above, according to the present invention, it is possible to prevent the duplicate recording of a broadcasting program by analyzing the correspondence ratio of additional information data. Accordingly, the recording unit can be used more effectively and much longer.

The present invention can be implemented on a recording unit with a code that is readable by a computer. The recording unit that can be read by a computer may include any kind of recording device in which data that is readable by the computer is stored. Examples of the recording unit include ROM, RAM, CD-ROM, magnetic tape, hard discs, floppy discs, flash memory, optical data storage devices, and even carrier waves, for example, transmission over the Internet. Moreover, the recording unit may be distributed among computer systems that are interconnected through a network, and the present invention may be stored and implemented as a code in the distributed system.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. A method of preventing a duplicate recording of a broadcasting program, comprising:
(a) before entering a recording mode, reading additional information corresponding to a to-be-recorded broadcasting program from an additional information storing unit, the additional information including title information and summary information;
(b) searching a recording unit and determining whether the recording unit stores title information corresponding to the to-be-recorded broadcasting program;
(c) if the title information corresponding to the to-be-recorded broadcasting program is detected from the recording unit in operation (b), comparing summary information included in the additional information read in operation (a) with that stored in the recording unit in connection with the detected title information, and then calculating a correspondence ratio; and
(d) comparing the correspondence ratio calculated in operation (c) with a predetermined reference value, and if the correspondence ratio is less than the predetermined reference value, entering the recording mode to enable recording of the to-be-recorded broadcasting program on the recording unit.

2. The method of claim 1, wherein the title information includes sub-title information.

3. The method of claim 1, further comprising producing a message informing that there is a broadcasting program already recorded in the recording unit, which broadcasting program may be identical to the to-be-recorded broadcasting program, when the correspondence ratio is greater than the predetermined reference value in operation (d).

4. An apparatus to prevent a duplicate recording of a broadcasting program, comprising:
a broadcasting signal receiving unit configured to select and to demodulate only broadcasting signals that correspond to a selected channel from received broadcasting signals, in accordance with a channel control signal;
an additional information storing unit configured to store additional information selected from the broadcasting signals received through the broadcasting signal receiving unit;
a recording unit configured to store a broadcasting program; and
a controller configured to implement control processes including reading additional information corresponding to a to-be-recorded broadcasting program from the additional information storing unit before entering a recording mode, the additional information including title information and summary information; searching the recording unit to determine whether the recording unit stores title information corresponding to the to-be-recorded broadcasting program; if the title information corresponding to the to-be-recorded broadcasting program is detected from the recording unit, comparing summary information included in the additional information read from the additional information storing unit with that stored in the recording unit in connection with the detected title information and then calculating a correspondence ratio; and comparing the calculated correspondence ratio with a predetermined reference value, and if the calculated correspondence ratio is less than the predetermined reference value, entering the recording mode to enable recording of the to-be-recorded broadcasting program on the recording unit.

5. The apparatus of claim 4, wherein the title information includes sub-title information.

6. The apparatus of claim 4, wherein the controller further implements a control process of producing a message informing that there is a broadcasting program already recorded in the recording unit, which broadcasting program may be identical to the to-be-recorded broadcasting program, when the correspondence ratio is greater than the predetermined reference value.

7. The apparatus of claim 4, wherein the recording unit is a hard disc drive.

8. The apparatus of claim 4, wherein the summary information includes at least one of program date information, program time information, and program length information.

9. A method of preventing duplicate recording of a broadcasting program, comprising:
(a) before executing a recording command, reading additional information corresponding to a to-be-recorded broadcasting program from an additional information storing unit, the additional information including title information;
(b) searching a recording unit and determining whether the recording unit stores title information corresponding to the to-be-recorded broadcasting program;
(c) if the title information corresponding to the to-be-recorded broadcasting program is detected from the recording unit in operation (b), ignoring the recording command.

10. The method of claim 9, wherein the title information includes information on a sequence number of the to-be-recorded broadcasting program.

11. An apparatus to prevent duplicate recording of a broadcasting program, comprising:
a broadcasting signal receiving unit configured to select and to demodulate only broadcasting signals that correspond to a selected channel from received broadcasting signals, in accordance with a channel control signal;
an additional information storing unit configured to store additional information selected from the broadcasting signals received through the broadcasting signal receiving unit;
a recording unit configured to store a broadcasting program; and
a controller configured to implement control processes including (a) before executing a recording command, reading additional information corresponding to a to-be-recorded broadcasting program from a additional information storing unit, the additional information including title information; (b) searching a recording unit and determining whether the recording unit stores title information corresponding to the to-be-recorded broadcasting program; and (c) if the title information corresponding to the to-be recorded broadcasting program is detected from the recording unit in operation (b), ignoring the recording command.

12. The apparatus of claim 11, wherein the title information includes information on a sequence number of the to-be-recorded broadcasting program.

13. An apparatus to prevent a duplicate storing of a transmitted program, the apparatus comprising:
a signal detector configured to detect additional information associated with the transmitted program, the additional information comprising at least title information and auxiliary information; and
a controller configured to determine if the title information of the transmitted program detected by the signal detector corresponds to title information of a stored program retrieved from an additional information storing unit and, if so, to determine a similarity between the auxiliary information of the transmitted program and auxiliary information of the stored program retrieved from the additional information storing unit, and to output an output signal to enable recording of the transmitted program if it is judged, based on the similarity between the auxiliary information of the transmitted program and the auxiliary information of the stored program, that the transmitted program is to be stored.

14. The apparatus of claim 13, wherein the similarity determination between the auxiliary information of the transmitted program and the auxiliary information of the stored program includes calculating a correspondence ratio between the auxiliary information of the transmitted program and the auxiliary information of the stored program, and comparing the calculated correspondence ratio with a predetermined reference value.

15. The apparatus of claim 13, wherein the title information includes program sequence number information.

16. The apparatus of claim 13, wherein the broadcasting program is one of a television frequency signal and a cable signal.

17. The apparatus of claim 13, wherein the auxiliary information includes at least one of summary information, program date information, program time information, and program length information.
